(19) United States
(12) Patent Application Publication
(10) Pub. No.: US 2008/0248076 A1
(43) Pub. Date: Oct. 9, 2008

(54) ANTIMICROBIAL RUBBER BANDS

(76) Inventors: Anders H. Johansson, Yardley, PA (US); Bonnie Jean Swayze, Franklin, KY (US); Susan D. Clark, Hot Springs, AR (US); John W. Ellis, Hot Springs, AR (US); Charles R. Hodges, Hot Springs, AR (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/697,314

(22) Filed: Apr. 6, 2007

(51) Int. Cl. A01N 25/08; A01N 57/02; A01N 59/16

(52) U.S. Cl. 424/411; 424/600; 424/641; 424/703

(57) ABSTRACT

An antimicrobial vulcanized rubber article that includes at least one rubber component; and an antimicrobial agent selected from the group consisting of zinc pyrithione, zinc dimethyldithiocarbamate, and chlorhexidine base.

### FIELD OF THE INVENTION

The present invention relates generally to antimicrobial vulcanized rubber articles that include a rubber component and an antimicrobial agent.

### BACKGROUND OF THE INVENTION

The hazards of bacterial contamination from potential everyday exposure are well known. Noteworthy examples include the fatal consequences of food poisoning due to certain strains of Escherichia coli being found within raw spinach or undercooked beef; Salmonella enteritidis contamination causing sicknesses from undercooked and unwashed poultry food products; and illnesses and skin infections attributed to Staphylococcus aureus, Klebsiella pneumoniae, yeast (Candida albicans), and other unicellular organisms. With such an increased consumer interest in this area, manufacturers have begun introducing antimicrobial agents within various everyday products and articles. For instance, certain brands of cutting boards, shoe soles, shoe inserts, medical devices and implements, liquid soaps, etc., contain antimicrobial compounds. One popular antimicrobial for such articles is triclosan. Although the incorporation of such a compound within liquid or certain polymeric media has been relatively simple, other substrates, specifically vulcanized rubber and surfaces thereof, have proven less accessible. Furthermore, triclosan additives have proven to be difficult in use or ineffective for certain bacteria. For instance, triclosan itself migrates easily within and out of certain polymeric substrates and/or matrices and thus is not very durable, lacks thermal stability, and does not provide a wide range of bacterial kill. For example, it has been reported that triclosan has little or no efficacy against Pseudomonas aeruginosa.

Another type of antimicrobial agent that has been used is silver compounds. However, silver compounds can be expensive, and can cause discoloration or staining.

Vulcanized rubber articles are utilized in many different applications, from automobiles hoses, tires, bumpers, etc., to household items such as toys, sink washers, gaskets, appliances, floor mats, door mats, carpeted rubber mats, gloves, rubber bands, and the like. Bacterial growth is a potential problem in these applications. Thus, there is a need to provide effective, durable, vulcanized rubber formulations that will provide long-term antimicrobial effects within a vulcanized article. Furthermore, it would be desirable if the vulcanized rubber article could provide antimicrobial efficacy to the area immediately surrounding the article.

Japanese Patent Application 1997-342076 discloses the production of unvulcanized rubber formulations and articles exhibiting antibacterial properties due to the presence of silver complexes. Antimicrobial rubber bands have been taught in Japanese Patent Application 1997-140034 in vulcanized form with silver antimicrobials therein.

Furthermore, rubber latexes (non-vulcanized) comprising antimicrobials have been disclosed (U.S. Pat. No. 5,736,591, for example), as have floor mats having silver-based antimicrobials incorporated within pile fiber components and which have non-antimicrobial rubber backings cured through peroxide-catalyzed vulcanization to protect the pile fiber antimicrobial compounds from attack by any sulfur compounds (as in Japanese Patent Applications 1993-3555168 and 1995-38991).

U.S. Pat. Nos. 6,448,306, 6,555,599, 6,638,993, 6,848,871, 6,852,782, 6,943,205, and 7,060,739 teach the use of silver-based antimicrobial agents in some sort of rubber matrix. Different rubber matrices include fluoroelastomer rubber, non-silicone rubber, styrene butadiene rubber, prevulcanized and resin cured rubber, butadiene and/or natural rubber, and rubber where the majority is ethylene-propylene-diene-monomer (EPDM) or acrylonitrile-butadiene (NBR).

Antimicrobial rubber formulations are certainly highly desired for the production of vulcanized rubber articles and compositions to provide not only antibacterial benefits, but also antifungal, antimildew, antistaining, and odor control properties.

### SUMMARY OF THE INVENTION

In general the present invention provides an antimicrobial vulcanized rubber article that includes at least one rubber component, and an antimicrobial agent selected from the group consisting of zinc pyrithione, zinc dimethyldithiocarbamate, and chlorhexidine base.

The present invention also includes a method for preparing an antimicrobial rubber article, the method comprising combining a rubber component, an antimicrobial agent selected from the group consisting of zinc pyrithione, zinc dimethyldithiocarbamate, and chlorhexidine base, and a cure package to form a vulcanizable mixture; and curing the vulcanizable mixture.

The present invention further provides an antimicrobial vulcanized rubber article comprising at least one rubber component; and an antimicrobial agent selected from the group consisting of zinc pyrithione, zinc dimethyldithiocarbamate, and chlorhexidine base, wherein said article exhibits efficacy against one or more of gram positive bacteria, gram negative bacteria, fungi, and algae.

### DETAILED DESCRIPTION OF ILLUSTRATIVE EMBODIMENTS

One or more embodiments of the present invention provide an antimicrobial vulcanized rubber article that includes at least one rubber component, and an antimicrobial agent.

Any antimicrobial agent known in the art may be used, with the proviso that the agent is insoluble in water and able to withstand rubber processing and curing conditions without losing antimicrobial efficacy or interfering with the cure system. In one or more embodiments, the antimicrobial agent includes zinc pyrithione, zinc dimethyldithiocarbamate, chlorhexidine base, or mixtures thereof.

In one embodiment, the antimicrobial agent includes zinc pyrithione, which is available commercially, for example under the brand name Zinc Omadine® by Arch Chemicals, Inc. Zinc pyrithione is sometimes referred to as zinc 2-pyridinethiol-n-oxide, or bis(1-hydroxy-2(1H)-pyridineselonate-O,S)zinc. Zinc pyrithione may be represented by the summary chemical formula C₁₀H₈N₂O₂S₂Zn. Another designation sometimes given to zinc pyrithione is CAS # 13463-41-7.

In these or other embodiments, the antimicrobial agent includes zinc dimethyldithiocarbamate. Zinc dimethyldithiocarbamate is available commercially, for example from R.T. Vanderbilt Company, Inc. under the trademark Vancide® DM.

In these or other embodiments, the antimicrobial agent includes chlorhexidine base, sometimes referred to as N,N′-Bis(4-chlorophenyl)-3,12-diimino-2,4,11,13-tetraazatetradecanediimidamide. Chlorhexidine base is available commercially, for example from DeGussa Corporation.

The amount of antimicrobial is not particularly limited. In one or more embodiments, the antimicrobial rubber composition includes at least about 100 parts per million by weight of antimicrobial agent, based upon the total weight of rubber component. In other embodiments, the antimicrobial rubber composition includes at least about 200 parts per million by weight of antimicrobial agent, and in yet other embodiments, the antimicrobial rubber composition includes at least about 500 parts per million by weight of antimicrobial agent, based upon the total weight of rubber component.

In one or more embodiments, the antimicrobial agent is present in an amount of from about 100 to about 2000 parts per million by weight, based upon the total weight of rubber component. In other embodiments, the antimicrobial agent is present in an amount of from about 200 to about 1000 parts per million by weight, based upon the total weight of rubber component. In yet other embodiments, the antimicrobial agent is present in an amount of from about 300 to about 700 parts per million by weight, based upon the total weight of rubber component.

Any vulcanizable rubber component known in the art may be employed. The rubber component of the inventive raw rubber formulation may include mixtures of types of rubber in order to provide different strengths, flexibilities, ozone resistance, or other properties.

In one or more embodiments, the antimicrobial rubber composition includes synthetic rubber, natural rubber, or mixtures thereof. The rubber component may include nitrile rubber, such as acrylonitrile-butadiene (NBR), natural rubber, butadiene-type rubber, styrene-butadiene rubber (SBR), chloroprene, ethylene propylene diene modified rubber (EPDM), polyurethane rubber, butyl rubbers, neoprene, isoprene, polyisoprene, halobutyl rubbers, fluoroelastomers, epichlorohydrin rubber, polyacrylate rubber, and chlorinated polyethylene rubber. Modified rubbers may also optionally be employed, including hydrogenated SBR, hydrogenated NBR, and carboxylated NBR and the like. Silicone rubber may also optionally be employed. Mixtures, copolymers, and terpolymers of the above rubbers may also be used.

In one or more embodiments, the antimicrobial rubber composition includes from about 25 to about 95 percent by weight (wt. %) rubber, based upon the total weight of the antimicrobial composition. In other embodiments, the antimicrobial rubber composition includes from about 35 to about 90 wt. % rubber, based upon the total weight of the antimicrobial composition. In yet other embodiments, the antimicrobial rubber composition includes from about 40 to about 85 wt. % rubber, based upon the total weight of the antimicrobial composition.

Other optional ingredients that may be employed include fillers, oils, curing agents, blowing agents, and other ingredients known in the art. Other optional additives to the rubber formulation include release control additives, accelerators, accelerator activators, antidegradants, softeners, abrasives, colorants, flame retardants, homogenizing agents, internal lubricants, and deodorants. Such components may be present, if at all, in amounts, of from about 0.1 to about 10 parts per hundred parts rubber (phr).

Examples of cure agents include sulfur-based cure agents, peroxide cure agents, and other cure agents known in the art. In one or more embodiments, the vulcanized rubber article is prepared by using a sulfur-containing cure package.

In one or more embodiments, the antimicrobial rubber composition is substantially latex-free.

The present invention also provides a method for preparing an antimicrobial rubber article. In one or more embodiments, the method comprises combining a rubber component, an antimicrobial agent selected from the group consisting of zinc pyrithione, zinc dimethyldithiocarbamate, and chlorhexidine base, and a cure package to form a vulcanizable mixture, and curing the vulcanizable mixture. In certain embodiments, the antimicrobial agent is dispersed throughout the rubber component.

The antimicrobial composition may be prepared by compounding the ingredients as is known in the art of rubber formulations. In one or more embodiments, the compounding may be carried out in an open mill, an internal mixer, or an extruder where intensive mixing within the polymer matrix of each component will take place. During the mixing operation, the control of temperature rise, due to high shear incorporation of the ingredients, may be controlled to ensure that pre-vulcanization (scorch) does not take place during processing.

The compounds can be further processed after mixing into specific forms to allow adequate presentation for manufacturing into products. This may include calendering, extrusion, granulation/pelletization, strip form, fabrication and pre-forming into specific shaped blanks.

Vulcanization of the antimicrobial rubber composition may be accomplished via methods known in the art. In one or more embodiments, vulcanization may include molding (compression, transfer, injection), continuous extrusion (LCM, UHF, autoclave and hot air), and coatings. In one or more embodiments, the vulcanization (cure) temperatures may range from about 150° C. to about 250° C.

In one or more embodiments, the antimicrobial article is a rubber band. In these or other embodiments, the rubber component, antimicrobial agent, and optional other ingredients are mixed and heated in a banbury mixer to form a dough. When the dough reaches a desired temperature, the dough is transferred to a mill, where it is cooled and rolled into sheets. The sheets are split into strips and fed into a pressing machine such as an extruder. The extruder pushes the dough out in a tube form. This tube is then heated to finish the vulcanization, rinsed, cooled, and cut into bands. The speed of the process may reach about 3000 bands per minute.

The rubber bands may be made in a wide variety of sizes and shapes, and may be employed in conjunction with stationary and office supplies, produce and other food items, clothing and other textile products, cables and other household, retail, or manufacturing applications.

Advantageously, in one or more embodiments, the antimicrobial vulcanized rubber article of the present invention exhibits efficacy against one or more of gram positive bacteria, gram negative bacteria, fungi, and algae.

In certain embodiments, the antimicrobial agent is a bactericide-fungicide that imparts to the antimicrobial rubber product a broad spectrum antimicrobial efficacy against gram positive bacteria, gram negative bacteria, fungi and algae. In one or more embodiments, the antimicrobial agent exhibits efficacy against one or more bacteria including Pseudomonas aeruginosa, Pseudomonas cepacia, Escherichia coli, Klebsiella pneumoniae, Proteus mirabilis, Enterobacter aerogenes, Serratia marcescens, Salmonella choleraesuis, Shigella sonnei, Aceinetobacter calcoaceticus, Thiobacillus thioparus, Micrococcus luteus, Staphylococcus aureus, Methicillin Resistant S. aureus, Staphylococcus epidermidis, Streptococcus pyogenes, Streptococcus mitis, Streptococcus faecalis, Streptococcus pneumoniae, Micrococcus luteus, Lactobacillus plantarum, Pasteurella multocida, Streptoverticillium reticulum, and Bacillus subtilis.

In these or other embodiments, the antimicrobial agent exhibits antifungal efficacy against molds or yeast. In certain embodiments, the antimicrobial agent exhibits antifungal efficacy against one or more of Aspergillus niger, Cladosporium cladosporioides, Chaetomium globosum, Gliocladium virens, Penicillium funiculosum, Trichophyton mentagrophytes, Epidermophyton floccosum, Stachybotrys chartarum, Acremonium sp., Fusarium sp., Alternaria alternata, Aureobasidium pullulans, Saccharomyces cerevisiae, Candida albicans, Yarrowia lipolytica, and Pityrosporum ovale.

Efficacy against the organisms listed above may be measured as is known in the art, and for example by using an agar plate Zone of Inhibition test. Other tests include ASTM D 5590 and G 21. In one or more embodiments, the antimicrobial article of the present invention exhibits a zone of inhibition of at least about 0.5 centimeters (cm), when tested against gram positive bacteria, gram negative bacteria, fungi or algae, according to the Zone of Inhibition Test Protocol. In other embodiments, the antimicrobial article of the present invention exhibits a zone of inhibition of at least about 1 centimeters (cm), when tested against gram positive bacteria, gram negative bacteria, fungi or algae, according to the Zone of Inhibition Test Protocol. In other embodiments, the antimicrobial article of the present invention exhibits a zone of inhibition of at least about 1.5 centimeters (cm), when tested against gram positive bacteria, gram negative bacteria, fungi or algae, according to the Zone of Inhibition Test Protocol.

The Zone of Inhibition Test Protocol includes the following: for bacteria, the test organisms are grown overnight on Tryptic Soy Agar (TSA) slants at 35° C. Ten (10) milliliters of sterile water are added to wash bacteria from the slant and this suspension is diluted 1:10 in sterile water. One milliliter of dilute cell suspension is pipetted over the surface of a large Nunc® Bio-assay dish (245 mm×245 mm×20 mm) containing 100 mL of solidified Nutrient Agar and spread evenly with a sterile swab. Samples (0.75 inches×0.75 inches) are placed on top of the inoculated agar, plates are incubated overnight at 35° C. and zones of inhibited growth measured. The Zone of Inhibition is recorded as the distance from the edge of the sample to the start of growth. Molds and yeasts are tested in a similar manner, except that cultures are grown on Malt Agar slants (1 week at 28° C. grown for molds and overnight at 35° C. for yeasts). Mold spores are harvested in 10 mL sterile water and adjusted to 100,000 spores per milliliter. Yeast cells are prepared like bacteria. Fungal Zone of Inhibition testing is done on Malt Agar plates which are incubated 5-7 days at 28° C.

In order to demonstrate the practice of the present invention, the following examples have been prepared and tested. The examples should not, however, be viewed as limiting the scope of the invention. The claims will serve to define the invention.

### EXPERIMENTAL

### Toxicity Test on Rubber Band with Zinc Pyrithione

Test Scope: The Growth Inhibitor Test was used to determine the toxicity of a rubber band containing zinc pyrithione. Any presence of toxic residues in the test material (rubber band) will inhibit bacterial growth in the agar medium. A zone of inhibition or no growth of test organism around the test material indicates the presence of toxic residues in the test material. The intensity of inhibition is indicative of the concentration of the toxic agent.

Test Objective: Four (4) test organisms were used in this assay to determine toxicity. Each organism was suspended in specific agar medium, incubated at 35° C. for 48 hours, and then read to determine growth or no growth of test organism. Each test organism was grown individually in a Petri plate and the test material was planted unto the agar plate to determine the outcome. If no toxic residues were present in the test material, then the test bacteria grew around and under the test medium producing a “lawn effect.” If inhibitory substances were present in the test material, it would diffuse into the agar medium and prevent the growth of bacterial in the medium. The larger the zone of inhibition, the higher the concentration of toxic substances.

Test Organisms: The following four (4) organisms were employed: Escherichia coli, Staphylococcus aureus, Pseudomonas aeruginosa, and Pasteurella multocida. Each test organism's concentration was estimated to be 100,000 cfu to 1,000,000 cfu per milliliter.

Materials used included: 1. Baird Parker Agar for Staphylococcus aureus; 2. Standard Methods Agar for E. coli and Pseudomonas aeruginosa; 3. Tryptic Soy Agar for Pasteurella multocida; 4. 100 ppm chlorinated water to serve as a positive control; 5. Distilled water to serve as the negative control; 6. Quebec Colony Counter; 7. Incubator at 32.0 C; 8. Petri plates (85 mm diameter); 9. Vernier calibrators; 10. Tweezers and scissors; 11. Sterile ½ inch paper disc for controls.

### Test Procedure:

Agar mediums were prepared according to manufacture's directions and cooled to 46° C. before adding test organisms to agar medium to yield a concentration of 1 McFarland unit.

An aliquot of 20 ml of test organism/test agar medium was poured into a Petri plate, and allowed to solidify for one hour at room temperature.

Test Material—A swatch of rubber band material 1 centimeter square was cut and tested in duplicate (denoted Swatch #1 and Swatch #2 hereinbelow). A rubber band was also tested in duplicate (denoted Rubber Band #1 and Rubber Band #2 hereinbelow). Both the swatch of rubber band test material and the rubber band contained conventional rubber band material prepared by conventional methods except that 1000 ppm of zinc pyrithione was added to the rubber prior to vulcanization. The test material was placed onto agar test medium using a pair of tweezers. This step was repeated for each one of the four test organisms by placing a swatch of the test medium unto the middle of the Petri plate using tweezers.

Each test was done in duplicate. Three quality control plates were used to validate results of the test: the first plate contained just test organism and agar medium to prove that the organism grew well with no interference, on a second plate, a positive and negative controls was used to prove adequate response, a third plate contained just agar medium w/o a bacterial culture to prove that there was no contamination.

Each test plate was incubated for 48 hours at 32.0° C.

Upon completion of incubation, test plates were removed and if a zone of inhibition was present; it was measured to determine size of kill zone.

### Results:

Staphylococcus aureus Test Plates:

Swatch #1=3.2 centimeter (cm) zone of inhibition or “kill zone”
Swatch #2=3.2 cm kill zone
Rubber band #1=1.9 cm kill zone
Rubber band #2=1.9 cm kill zone

### +/−Control Plates:

Positive control disc #1 (Sodium Hypochlorite @ 100 ppm)=3.0 cm kill zone
Positive control disc #2 (Sodium Hypochlorite @ 100 ppm)=2.5 cm kill zone
Negative control disc #1=0.0 cm or no kill zone
Negative control disc #2=0.0 cm or no kill zone

Pseudomonas aeruginosa Test Plates:

Swatch #1=3.0 cm kill zone
Swatch #2=3.0 cm kill zone
Rubber band #1=1.7 cm kill zone
Rubber band #2=1.8 cm kill zone

### +/−Control Plates:

Positive control disc #1 (Sodium Hypochlorite @ 100 ppm)=3.1 cm kill zone
Positive control disc #2 (Sodium Hypochlorite @ 100 ppm)=3.0 cm kill zone
Negative control disc #1=0.0 cm or no kill zone
Negative control disc #2=0.0 cm or no kill zone

Pasteurella multocida Test Plates:

Swatch #1=2.9 centimeter (cm) zone of inhibition or “kill zone”
Swatch #2=3.0 cm kill zone
Rubber band #1=2.0 cm kill zone
Rubber band #2=2.0 cm kill zone

### +/−Control Plates:

Positive control disc #1 (Sodium Hypochlorite @ 100 ppm)=3.5 cm kill zone
Positive control disc #2 (Sodium Hypochlorite @ 100 ppm)=3.2 cm kill zone
Negative control disc #1=0.0 cm or no kill zone
Negative control disc #2=0.0 cm or no kill zone

E. coli Test Plates: Test Organism Died; This Assay was Invalid.

Swatch #1=2.3 centimeter (cm) zone of inhibition or “kill zone”
Swatch #2=2.6 cm kill zone
Rubber band #1=1.9 cm kill zone
Rubber band #2=2.0 cm kill zone

### +/−Control Plates:

Positive control disc #1 (Sodium Hypochlorite @ 100 ppm)=1.6 cm kill zone
Positive control disc #2 (Sodium Hypochlorite @ 100 ppm)=1.4 cm kill zone
Negative control disc #1=0.0 cm or no kill zone
Negative control disc #2=0.0 cm or no kill zone

Other Controls:
Standard Methods Agar Control=0 colonies
Baird Parker Agar Control=0 colonies
Tryptic Soy Agar Control=0 colonies
Each test organism was seeded unto specific agar to prove that the organism grew well with no interference. All cultures grew luxuriantly.
Rubber band soaked in Sodium Hypochlorite and seeded unto Staph Test Plate revealed=no growth
Rubber band soaked in Sodium Hypochlorite and seeded unto Staph Test Plate revealed=no growth

Both the zinc pyrithione-containing rubber swatch and rubber band (same product but in a different configurations) exhibited inhibitory effects upon all of the organisms tested. The toxicity of zinc pyrithione was equal to the potency of sodium hypochlorite at 100 ppm disinfection concentration as demonstrated by the similar kill zones.

Various modifications and alterations that do not depart from the scope and spirit of this invention will become apparent to those skilled in the art. This invention is not to be duly limited to the illustrative embodiments set forth herein.

What is claimed is:

1. An antimicrobial vulcanized rubber article comprising:
at least one rubber component; and
an antimicrobial agent selected from the group consisting of zinc pyrithione, zinc dimethyldithiocarbamate, and chlorhexidine base.

2. The antimicrobial vulcanized rubber article of claim 1, wherein the at least one rubber component includes synthetic rubber, natural rubber, or a mixture thereof.

3. The antimicrobial vulcanized rubber article of claim 1, wherein the at least one rubber component includes nitrile rubber, acrylonitrile-butadiene (NBR), natural rubber, butadiene-type rubber, styrene-butadiene rubber, chloroprene, ethylene propylene diene modified rubber (EPDM), polyurethane rubber, butyl rubber, neoprene, isoprene, polyisoprene, halobutyl rubber, fluoroelastomers, epichlorohydrin rubber, polyacrylate rubber, chlorinated polyethylene rubber, hydrogenated SBR, hydrogenated NBR, carboxylated NBR, silicone rubber, or mixtures, copolymers or terpolymers thereof.

4. The antimicrobial vulcanized rubber article of claim 1, wherein the antimicrobial agent includes zinc pyrithione.

5. The antimicrobial vulcanized rubber article of claim 1, wherein the antimicrobial agent is dispersed throughout the rubber component.

6. The antimicrobial vulcanized rubber article of claim 1, wherein the antimicrobial agent is present in an amount of from about 100 to about 2000 parts per million by weight, based upon the total weight of rubber component.

7. The antimicrobial vulcanized rubber article of claim 1, wherein said article is substantially latex-free.

8. A method for preparing an antimicrobial rubber article, the method comprising:
combining a rubber component, an antimicrobial agent selected from the group consisting of zinc pyrithione, zinc dimethyldithiocarbamate, and chlorhexidine base, and a cure package to form a vulcanizable mixture; and
curing the vulcanizable mixture.

9. The method of claim 8, wherein the at least one rubber component includes synthetic rubber, natural rubber, or a mixture thereof.

10. The method of claim 8, wherein the at least one rubber component includes nitrile rubber, acrylonitrile-butadiene (NBR), natural rubber, butadiene-type rubber, styrene-butadiene rubber, chloroprene, ethylene propylene diene modified rubber (EPDM), polyurethane rubber, butyl rubber, neoprene, isoprene, polyisoprene, halobutyl rubber, fluoroelastomers, epichlorohydrin rubber, polyacrylate rubber, chlorinated polyethylene rubber, hydrogenated SBR, hydrogenated NBR, carboxylated NBR, silicone rubber, or mixtures, copolymers or terpolymers thereof.

11. The method of claim 8, wherein the antimicrobial agent includes zinc pyrithione.

12. The method of claim 8, wherein the antimicrobial agent is dispersed throughout the rubber component.

13. The method of claim 8, wherein the antimicrobial agent is present in an amount of from about 100 to about 2000 parts per million by weight, based upon the total weight of rubber component.

14. The method of claim 8, wherein said article is substantially latex-free.

15. The method of claim 8, wherein said cure package comprises sulfur or peroxide.

16. An antimicrobial vulcanized rubber article comprising:
at least one rubber component; and
an antimicrobial agent, wherein said vulcanized rubber article is prepared by using a sulfur-containing cure package.

17. An antimicrobial vulcanized rubber article comprising:
at least one rubber component; and
an antimicrobial agent selected from the group consisting of zinc pyrithione, zinc dimethyldithiocarbamate, and chlorhexidine base, wherein said article exhibits efficacy against one or more of gram positive bacteria, gram negative bacteria, fungi, and algae.

18. The antimicrobial article of claim 17, wherein said article exhibits antimicrobial effectiveness against one or more of Pseudomonas aeruginosa, Pseudomonas cepacia, Escherichia coli, Klebsiella pneumoniae, Proteus mirabilis, Enterobacter aerogenes, Serratia marcescens, Salmonella choleraesuis, Shigella sonnei, Aceinetobacter calcoaceticus, Thiobacillus thioparus, Micrococcus luteus, Staphylococcus aureus, Methicillin Resistant S. aureus, Staphylococcus epidermidis, Streptococcus pyogenes, Streptococcus mitis, Streptococcus faecalis, Streptococcus pneumoniae, Micrococcus luteus, Lactobacillus plantarum, Pasteurella multocida, Streptoverticillium reticulum, and Bacillus subtilis.

19. The antimicrobial article of claim 17, wherein said article exhibits antimicrobial effectiveness against one or more of Escherichia coli, Staphylococcus aureus, Pseudomonas aeruginosa, and Pasteurella multocida.

20. The antimicrobial article of claim 17, wherein said article exhibits antifungal efficacy against one or more molds or yeast.

21. The antimicrobial article of claim 17, wherein said article exhibits antifungal efficacy against one or more of Aspergillus niger, Cladosporium cladosporioides, Chaetomium globosum, Gliocladium virens, Penicillium funiculosum, Trichophyton mentagrophytes, Epidermophyton floccosum, Stachybotrys chartarum, Acremonium sp., Fusarium sp., Alternaria alternata, Aureobasidium pullulans, Saccharomyces cerevisiae, Candida albicans, Yarrowia lipolytica, and Pityrosporum ovale.

22. The article of claim 17, wherein the antimicrobial agent is present in an amount of from about 100 to about 2000 parts per million by weight, based upon the total weight of rubber component.

23. The article of claim 17, wherein the antimicrobial article of the present invention exhibits a zone of inhibition of at least about 0.5 centimeters (cm), when tested against gram positive bacteria, gram negative bacteria, fungi or algae, according to the Zone of Inhibition Test Protocol.
